(19) United States
(12) Patent Application Publication
(10) Pub. No.: US 2021/0224932 A1
(43) Pub. Date: Jul. 22, 2021

(54) AUTOMATIC ESTATE MANAGEMENT WITH INTERNET OF THINGS DEVICES

(71) Applicant: Wells Fargo Bank, N.A., San Francisco, CA (US)

(72) Inventors: Michael Blacksburg, Durham, NC (US); Chris Theodore Kalaboukis, San Jose, CA (US); Julian Thiesfeldt Saltman, Berkeley, CA (US); Jackson Chin, San Francisco, CA (US); Miguel A. Ruiz, Walnut Creek, CA (US); Monica M. Bizjack, San Rafael, CA (US); Daniel Brian Allen, Austin, TX (US)

(21) Appl. No.: 15/691,644

(22) Filed: Aug. 30, 2017

(51) Int. Cl. G06Q 50/16; G05B 19/042; H04N 7/18; G06K 9/00; G06T 7/70

(52) U.S. Cl. CPC G06Q 50/163; G05B 19/042; G05B 2219/2614; G06K 9/00771; G06T 7/70; H04N 7/183

(57) ABSTRACT

A system includes at least one hardware processor and a memory storing instructions that, when executed by the at least one hardware processor, cause the at least one hardware processor to perform operations including identifying an estate management protocol associated with an estate of a focal subject, the estate management protocol includes an activation event and a plurality of management activities, the activation event defining a triggering event after which the system performs the plurality of management activities to manage the estate of the focal subject, determining that the activation event has occurred, based on the determining, initiating the plurality of estate management activities to manage aspects of the estate of the focal subject using one or more connected devices of the estate, and transmitting management commands to the one or more connected devices to complete the plurality of management activities.

### TECHNICAL FIELD

Embodiments described herein generally relate to computing systems and, for example and without limitation, to software systems and methods for automatic management of estate assets.

### BACKGROUND

As computer technology progresses, many consumer devices that were once isolated, stand-alone devices are becoming “connected devices,” leading to what is now referred to as an “Internet of Things” (IoT). For example, many household appliances such as refrigerators, washers and dryers, and thermostats, or other household systems such as lighting and security systems, are now being network connected such that they may communicate with each other, or such that they may be remotely controlled. This IoT shift in consumer devices provides fundamentally new tools that may provide ways to automatically manage tasks that may previously have been managed by a human, or that may not have been feasible at all.

### BRIEF DESCRIPTION OF THE SEVERAL VIEWS OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 illustrates an example networked environment including components of an estate management system for providing various estate management services for an estate of a focal subject;

FIG. 2 is a block diagram showing components within the estate management engine, according to some embodiments;

FIG. 3 illustrates the setup and configuration process associated with establishing management of the estate with the estate management engine;

FIG. 4A illustrates various security management activities associated with securing property of the estate using the security devices;

FIG. 4B illustrates various property management activities associated with managing the property of the estate using the property management devices;

FIG. 4C illustrates various utility management activities associated with managing the utilities used by the estate via the utility devices;

FIG. 5 illustrates an example computer-implemented method for managing the estate of the focal user, according to some embodiments; and

FIG. 6 is a block diagram illustrating a machine in the example form of a computer system, within which a set or sequence of instructions can be executed to cause the machine to perform any one of the methodologies discussed herein, according to some embodiments.

### DETAILED DESCRIPTION

In some life situations, a person may experience life events in which third party involvement in managing their estate may be invoked. For example, when a person dies, an estate executor may be responsible (e.g., legally, contractually, by obligation) for managing the estate and assets of the decedent, thereby securing the assets while the estate of the decedent is settled. Typically, the estate executor may need to travel to the decedent's property to perform various tasks that traditionally have required a physical presence at the property, such as changing the locks, assessing whether there are pets present, inventorying assets, securing automobiles, managing perishables such as food, and controlling utilities. Some automatic actions engaged remotely may save time and labor for estate executors. Further, certain automatic actions leveraging connected devices associated with the decedent's estate may help enhance security of the estate and estate assets, such as from prospective heirs that may not be aware that they should not remove estate assets before the estate is settled.

The systems and methods described herein describe technical solutions for automatically managing a person's estate and associated assets using various connected devices. More specifically, in an example embodiment, an estate management engine is configured to be activated upon an “activation event”, such as the incapacitation or death of a person (“focal subject”). Many of the examples provided herein are given in the context of the death of the focal subject, where the estate management engine is acting to, for example, monitor and control the estate and estate assets of the focal subject. As such, and though the term “decedent” may be used to refer to the focal subject, it should be understood that the activation event may include events other than the death of the focal subject in which management of the estate of the focal subject may be desired (e.g., illness, hospitalization, travel, absence).

In an example embodiment, upon activation, the estate management engine communicates with various connected devices of the decedent's estate (referred to herein as “estate devices”). The estate may include various types of connected devices which may be accessed by the estate management engine, such as home security devices (e.g., door access devices, security cameras, intrusion detection devices), automobile devices (e.g., remote tracking, shutdown, disabling), property management devices (e.g., thermostat, grounds management systems, pet management), computing devices (e.g., computers, smart televisions, networking devices, smartphones, tablets), and utility devices (e.g., refrigerator, lighting).

Each of these estate devices may be used, directly or indirectly, to manage some aspect of control of the focal subject's estate. For example, upon the death of the focal subject, the estate management engine may secure estate assets by engaging certain types of access devices to limit who can access the property, or engaging security cameras or intrusion detection devices to capture video when motion is detected, or disabling or securing automobiles associated with the estate. The estate management engine may perform aspects of property management by, for example, changing thermostat settings or sprinkler settings of a grounds maintenance system to preserve estate value, or engaging security cameras to detect the presence of pets that need to be managed, or engaging security cameras for purposes of inventorying certain estate assets, or managing lighting systems or utility usage for purposes of property security or value conservation. The estate management engine may automatically initiate the listing of an estate property for sale, or may automate an estate sale for various assets of the estate. The various remote estate management functionalities may serve to better secure the estate and estate assets, thereby protecting value for the heirs.

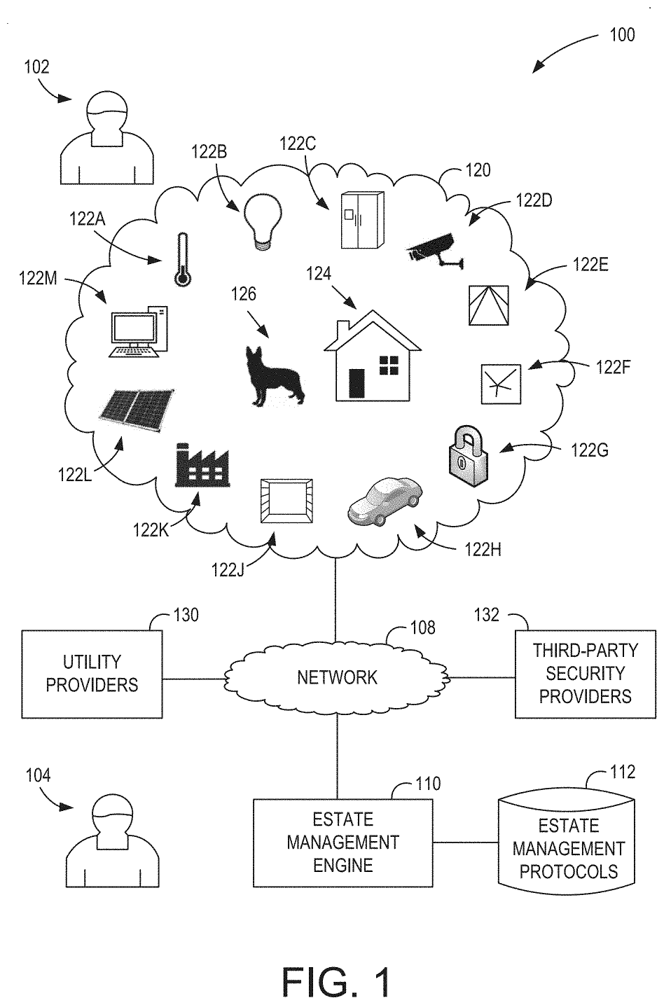

FIG. 1 illustrates an example networked environment including components of an estate management system 100 for providing various estate management services for an estate 120 of a focal subject 102. In an example embodiment, the estate management system 100 includes an estate management engine 110 coupled in networked communication via the network 108 (e.g., the Internet) with various devices (“estate devices”) 122 associated with the estate 120. The estate devices 122 provide various data or other functionality that the estate management engine 110 may use to manage the estate 120. Further, in some embodiments, the estate management engine 110 and various estate management services may be provided by an estate manager 104, such as an executor of a will of the focal subject 102.

The estate 120, in an example embodiment, includes real estate and personal property of the focal subject 102, generally represented in FIG. 1 as a house 124 for ease of discussion. The estate 120 may include multiple properties, such as a primary residence, secondary residences (e.g., vacation homes, apartments), storage units, and business properties (e.g., an office of a family-owned business, farm or agricultural property), or perhaps non-traditional homes such as a boat or a recreational vehicle. People typically keep much of their personal belongings at their residences. For example, at their primary residence, the focal subject 102 may keep clothing, appliances, furniture, electronics, automobiles, jewelry, and the myriad chattels that people collect during their lives. All of the real estate and chattels owned by the focal subject 102 represents the estate 120 of the focal subject 102, and thus is the subject of preservation concerns addressed by the estate management engine 110.

In an effort to preserve the estate 120, the estate management system 100 employs the various connected estate devices 122 of the estate 120. In an example embodiment, the estate devices 122 include connected property management devices such as a thermostat device 122A, a lighting system 122B, and various appliances 122C. The thermostat device 122A typically controls aspects of heating, ventilation, and air conditioning (HVAC) for a building such as the primary residence of the focal subject 102. Management of a property's HVAC via the thermostat device 122A can help preserve value of the estate 120 by, for example, limiting the use of heating and air conditioning during periods when the property is uninhabited while avoiding conditions that may damage the property (e.g., avoiding damage caused by freezing pipes or heat exposure). The lighting system 122B typically controls when lights are illuminated. Management of a property's lighting can help limit electricity usage while maintaining security and an external appearance that someone is still occupying the residence. The connected appliances 122C may include, for example, refrigerators, freezers, washers, dryers, dish washers, microwaves, and ovens. Some connected appliances may provide various features that allow the estate management system 100 to, for example, provide an inventory of refrigerators or freezers, or detect when an appliance has been manually activated, or allow remote activation or deactivation of the appliances.

In an example embodiment, the estate devices 122 include premise security devices such as camera devices (or just “cameras”) 122D, motion sensors 122E, intrusion sensors 122F, and access control devices 122G. Cameras 122D may be digital cameras configured to capture digital video of various views on the property, such as interior spaces of a house, garage, or exterior spaces such as doorways, driveways, and pools. In some embodiments, video from the cameras 122D may be transmitted to the estate management engine 110 for various uses described herein, such as collecting inventory data of personal property of the estate 120 and monitoring who comes and goes on the property. The motion sensors 122E and intrusion sensors 122F may be used to protect the security of the estate 120, such as detecting movement within interior spaces during times when access is not authorized, or detecting break-ins on the property. The access control devices 122G may be installed on doors or other entryways on the property, allowing coded electronic access to the interior spaces of the property (e.g., via keycard our touchpad access to doors, garage door, gate, and so forth). In some embodiments, any of the cameras 122D, the motion sensors 122E, intrusion sensors 122F, and access control devices 122G may be part of a security system provided by a third-party security provider 132, which may be configured to communicate with the estate management engine 110 to facilitate any of the functionality described herein.

The estate devices 122, in some embodiments, may include computer control devices embedded in vehicles 122H (e.g., automobiles, farm equipment) of the estate 120. For example, some vehicles 122H may include security systems that enable owners such as the focal subject 102 to remotely disable the vehicle 122H, or detect the location of the vehicle 122H, or determine who is currently operating the vehicle 122H. As such, the estate management engine 110 may utilize such remote functionality to protect the vehicles 122H of the estate 120.

In some embodiments, the focal subject 102 may maintain storage spaces 122J in off-premise locations where the focal subject 102 may store personal property. Many of the same estate devices 122 may be utilized to secure or monitor those storage spaces 122J and, as such, may similarly be used by the estate management engine 110 to manage the storage spaces 122J.

In some embodiments, the estate devices 122 may include one or more utility management devices 122K that control aspects of utility usage of a property. Properties typically use several metered utilities from utility providers 130, such as electricity, gas, water, phone networks, or Internet access. As such, the estate management engine 110 may interact with the utility management devices 122K during management of the estate 120 (e.g., shutting off utility usage for a property, or providing usage values associated with the property). In some embodiments, the utility management devices 122K may be local to a property (e.g., managed by the focal subject 102, or managed by a utility provider 130). In other embodiments, the utility management devices 122K may be remote from the property (e.g., managed by the utility provider 130).

In some embodiments, the estate 120 may include a distributed electricity generation system 122L. For example, the primary residence of the focal subject 102 may include solar panels or wind generators used to generate electricity. These distributed electricity generation systems 122L typically connect to the local electric grid such that unused electricity may be sold back to the electric utility provider 130. As such, the estate management engine 110 may be configured to, for example, ensure that the electricity generation system 122L is operational and providing power to the property or back to the grid.

In some embodiments, the estate 120 may include animals 126 (e.g., house pets, farm animals) owned by the focal subject 102. Detecting the presence of such animals 126 may be important to managing the estate 120. As such, the estate management engine 110 may use some of the estate devices 122 to detect (e.g., using object recognition) the presence of or otherwise monitor the animals 126 through, for example, detecting motion in the house when not anticipated, or capturing images of an animal 126 on the property.

During setup and configuration of the estate management system 100 with the estate 120, the focal subject 102 and the estate manager 104 may define the scope of coverage of the estate management system 100 with respect to the estate 120, such as which real estate is covered and which personal property is covered, including which estate devices 122 that are to be used for managing that estate 120. The focal subject 102 may work with the estate manager 104 to configure and permission the estate management engine 110 to communicate with and control aspects of the various estate devices 122 available to the estate 120. For example, a personal or a third-party security provider 132 may be configured to communicate with the estate management engine 110, giving access, alert, or control functionality to the estate management engine 110 for monitoring or securing the property upon activation. The focal subject 102 may configure various vehicles 122H to communicate with the estate management engine 110, allowing the estate management engine 110 to monitor or secure the vehicles 122H as needed.

The estate management engine 110 may be configured in advance with various pre-defined estate management protocols 112 to be engaged at the time of an activation event, such as the death of the focal subject 102. For example, the focal subject 102 or the estate manager 104 may wish to lock down access to the property of the estate 120 when first informed of the death of the focal subject 102. For another example, the focal subject 102 or the estate manager 104 may wish to engage security monitoring of the property, perhaps even to a greater extent than may have been active prior to the activation event (e.g., capturing security footage of the interior spaces to document or prevent prospective heirs from accessing the property of the estate 120). The estate management protocols 112 for the focal subject 102 represent the pre-configured actions to be taken upon occurrence of the activation event. Accordingly, different actions may occur upon detection of a death of the focal subject compared to the incapacitation or an extended absence of the focal subject. In some embodiments, the focal subject 102 may assist in defining those estate management protocols 112 (e.g., based on their wishes). In some embodiments, the estate manager 104 may define such estate management protocols 112 (e.g., based on obligations to manage the estate 120).

In some embodiments, the estate management engine 110 may perform various operations with regard to personal computing devices 122M of the estate 120. Such personal computing devices 122M may include, for example, desktop computers, storage arrays, network devices (e.g., wireless routers, modems), tablets, and smartphones. In some embodiments, the location of certain devices such as smartphones and tablets of the focal subject 102 may be tracked and located (e.g., via GPS). In some embodiments, the estate management engine 110 may disable access to various devices, such as by changing account passwords or Wi-Fi passwords (e.g., to secure access to those devices or networks), or by powering down certain devices. In some embodiments, the estate management engine 110 may initiate local or remote backups of the electronic files on the computing devices 122M (e.g., to preserve important files from a desktop computer, or to preserve contact information from a smartphone).

During operation, the estate management engine 110 and associated protocols 112 are engaged after a pre-determined activation event occurs. In an example embodiment, the estate manager 104 may be informed of or otherwise detect the occurrence of an activation event, such as hearing of the death of the focal subject 102, or may be informed by the focal subject 102 that they plan to travel abroad for an extended period of time and wish to engage estate management. In some embodiments, the estate management engine 110 may automatically determine that estate management should commence. The estate management engine 110 may passively monitor activity on the estate to determine a level of inactivity (e.g., where the activation event is a length of inactivity associated with some monitored aspect of the estate). For example, the estate management engine 110 may initiate estate management after determining that a primary refrigerator on the estate had not been opened in several days, or after determining that items have spoiled, or that frequently used lights had not been turned on or off during normal usage times, or that there was no appliance usage (e.g., use sensors in showers, doors), or that no movement was detected within the primary residence, or some combination thereof (e.g., for event correlation), or based on limited utility usage (e.g., low water usage), or after a period of inactivity on a frequented social media site.

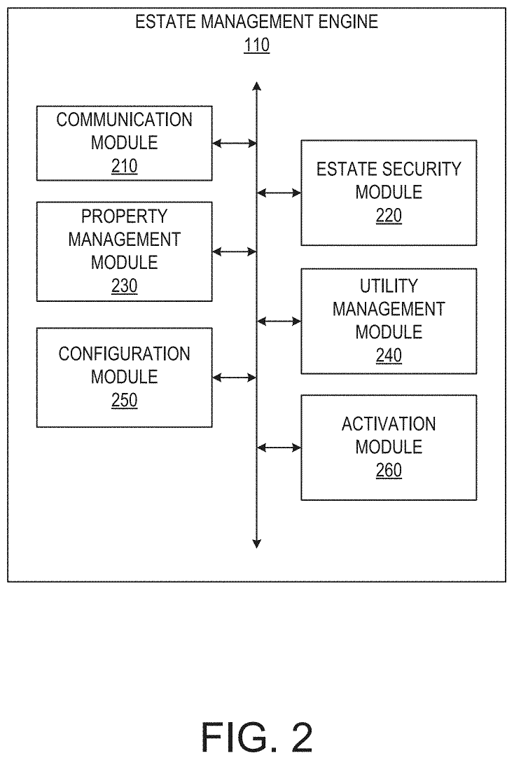

FIG. 2 is a block diagram showing components within the estate management engine 110, according to some embodiments. The estate management engine 110 may be hosted on dedicated or shared server machines (not shown) that are communicatively coupled to facilitate communications between the server machines. The components themselves may be communicatively coupled to each other and to various data sources, so as to allow information to be passed among the components or so as to allow the components to share and access common data. Furthermore, the components may access one or more databases (e.g., estate management protocols 112) via database servers (not separately shown). In the example embodiment, the estate management engine 110 includes a communication module 210, an estate security module 220, a property management module 230, a utility management module 240, a configuration module 250, and an activation module 260.

The communication module 210, in an example embodiment, provides network communication functionality between the estate management engine 110 and other computing devices, such as the estate devices 122, the utility providers 130, and the third-party security providers 132. In some embodiments, the communication module 210 facilitates communication over the Internet (e.g., the network 108) or other Internet Protocol (IP) based networks (e.g., IEEE 802 standards). In some embodiments, the communication module 210 facilitates communication to devices over cellular networks (e.g., to smartphone or tablet devices over a 3G/4G network). In other embodiments, the communication module 210 allows the estate management engine 110 to communicate over both IEEE 802 standard-based network and a cellular network at the same time.

In an example embodiment, the estate security module 220 provides functionality associated with security of the estate 120. The security module 220 may, for example, engage security cameras 122D, capture and analyze digital video, receive sensor data from the motion sensors 122E or the intrusion sensors 122F, configure or control access to the various premises or internal areas of the estate 120 via the access control devices 122G, and other such security features described herein. Via the communication module 210, the estate security module 220 may receive camera and sensor data for analysis, communicate with the various estate devices 222, and transmit commands to those estate devices 222.

The property management module 230, in an example embodiment, provides functionality associated with managing aspects of the property of the estate 120. The property management module 230 may, for example, control the thermostat device 122A of the property to manage internal environments, or manage the lighting system 122B, or access refrigeration inventories of the appliances 122C, or detect the presence of animals 126 within the estate 120, or other such property management features described herein. In some embodiments, the property management module 230 may capture digital video of personal property of the estate 120, create a partial inventory of personal property located within the estate 120 (e.g., via object recognition), and may compare the inventory or earlier video to later video to detect property removal.

In an example embodiment, the utility management module 240 provides functionality associated with managing aspects of utility usage of the estate 120. The utility management module 240 may, for example, track and report electric, gas, or water usage, or issue an alert when certain utility usage is over a pre-determined threshold, or disable certain utilities. In some embodiments, the utility management module 240 may communicate, via the communication module 210, with utility providers (e.g., utility providers 130) such as electric companies, gas companies, or water companies to effect changes to the utilities provided to the estate 120. In some embodiments, the utility management module 240 may manage local distributed generation systems 122L.

The configuration module 250, in an example embodiment, manages aspects of setup and configuration of the estate 120 and estate devices 122 to work with the estate management engine 110 per the wishes of the focal subject 102 or the obligations of the estate manager 104. Via the configuration module 250 and the communication module 210, the estate management system 100 is configured to communicate with the estate devices 122, and allow the subject 102 or the estate manager 104 to define and engage the various estate management protocols 112 and activation events for the estate 120.

In an example embodiment, the activation module 260 is used to initiate estate management functionality of the estate management system 100 with respect to the estate 120 of the focal subject 102. In some embodiments, though the estate management engine 110 may be pre-configured to communicate with the various estate devices 122, the estate management engine 110 may not be performing any management activities other than, for example, regular monitoring of continued connectivity and access to the estate devices 122 (e.g., for purposes of confirming readiness for eventual estate management). In other words, prior to the activation event, the estate management engine 110 may be largely “idle” with respect to the estate 120 (e.g., not collecting video, or monitoring security, or managing the property). Upon occurrence of the pre-defined activation event(s), such as the death of the focal subject 102, the activation module 260 causes the estate management protocols 112 for the estate 120 to be activated, thereby causing the estate security module 220 to begin managing various aspects of security, the property management module 230 to begin managing various aspects of the property, and the utility management module 240 to begin managing various aspects of utility usage of the estate 120. In some embodiments, the estate manager 104 acknowledges the occurrence of the activation events via the activation module 260. In some embodiments, the activation module 260 may be configured to monitor and automatically detect occurrence of the activation events.

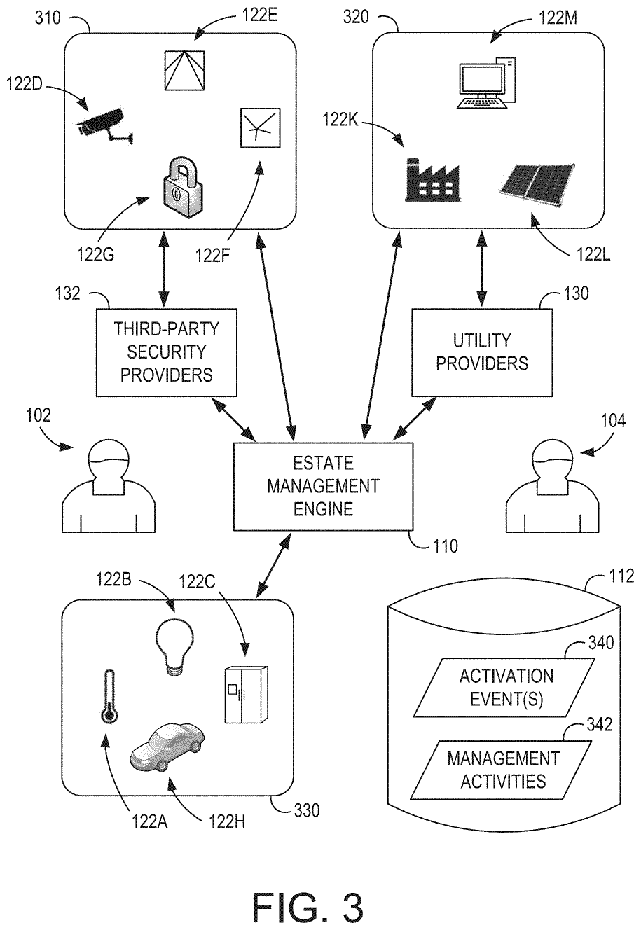

FIG. 3 illustrates the setup and configuration process associated with establishing management of the estate 120 with the estate management engine 110. In an example embodiment, the focal subject 102, and possibly the estate manager 104, perform two main setup steps to stage the estate 120 for future management by the estate management engine 110, connecting the estate devices 122 and building the estate management protocols 112. For ease of description, the estate devices 122 are presumed to be already physically installed on the estate 120 and configured to connect to the network 108. It should be understood that some device or network configuration on the estate 120 may be necessary to enable the estate devices 122 to communicate on the network 108, or specifically with the estate management engine 110.

In an example embodiment, and as shown in FIG. 3, many of the estate devices 122 are shown organized based on primary function or use. Security devices 310 include devices that may be used for purposes of securing the estate 120 such as, for example, the camera devices 122D, the motion sensors 122E, the intrusion sensors 122F, and the access control devices 122G. Utility devices 320 include devices that involve or provide utility services to the estate 120, including, for example, the utility management devices 122K, the local distributed generation systems 122L, and the computing devices 122M. Property management devices 330 include devices that may be used for purposes of managing other aspects of the estate 120, such as, for example, the thermostat device 122A, the lighting system 122B, the appliances 122C, and the vehicles 122H. While the estate devices 122 depicted in FIG. 3 are logically categorized based on example uses, it should be understood that some devices may be used for multiple uses, or for uses across these functional categories. For example, the camera devices 122D, though appearing in the security devices 310 category, may also be used for other functions, such as property management (e.g., capturing video for inventory analysis).

The setup phase, in an example embodiment, includes establishing network connectivity and access permission between some or all of the security devices 122 and the estate management engine 110. In some embodiments, the estate management engine 110 communicates directly with the devices 122 themselves (“direct communication”). For example, the estate management engine 110 may be configured to communicate directly with the camera devices 122D, along with a login and password, such that the estate management engine 110 is then capable of performing operational commands native to the camera devices 122D (e.g., initiating digital video capture, downloading captured video, rotating the camera devices 122D, and so forth). In some embodiments, the estate management engine 110 may communicate with other third-party systems to effect functionalities. For example, the estate management engine 110 may be configured and permissioned to communicate (e.g., via an application programming interface (API)) with the third-party security provider 132 associated with the estate 120 who controls or otherwise has access to the security devices 310. It should be understood that each security device 122 or third-party system may have different communication and access control methods. After the setup phase is complete, the estate management engine 110 has access to the security devices 122 or third-party systems sufficient to allow performance of the operations described herein.

The setup phase, in an example embodiment, also includes establishing the protocols 112 that define how the estate 120 will be managed by the estate management engine 110. As mentioned above, the protocols 112 may be pre-defined by any combination of the focal subject 102 and the estate manager 104. Defining the protocols 112 include defining one or more activation events 340 (e.g., when the estate management engine 110 is to begin actively managing aspects of the estate) and defining one or more management activities 342 (e.g., once activated, what activities will be performed by the estate management engine 110). Example activation events 340 include, for example, the death of the focal subject 102, the incapacity of the focal subject 102, or an absence of the focal subject 102 from one or more of their properties (e.g., extended travel, working away from the property). Many management activities 342 are described herein, and are outlined in greater detail below.

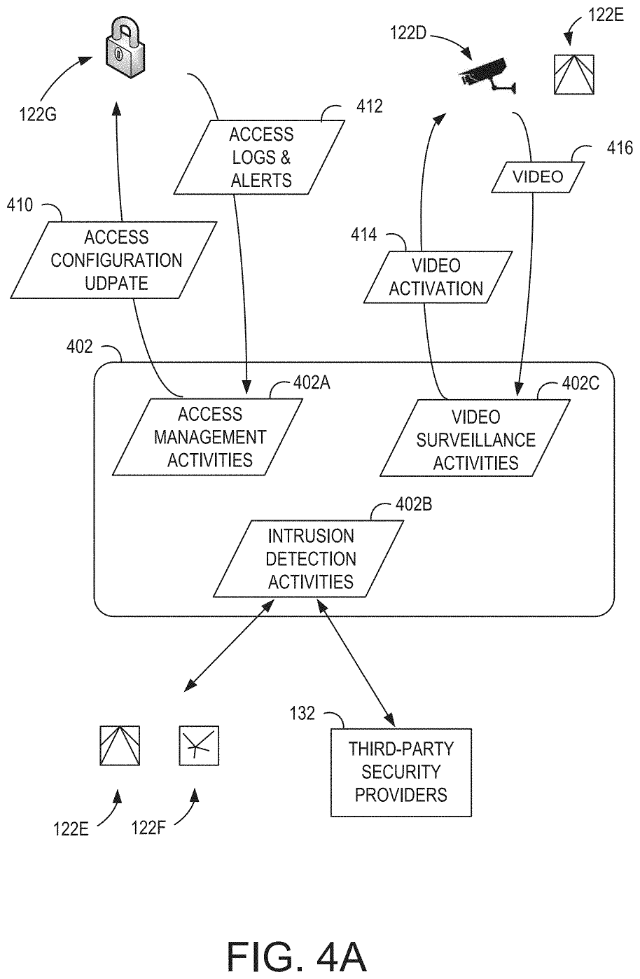

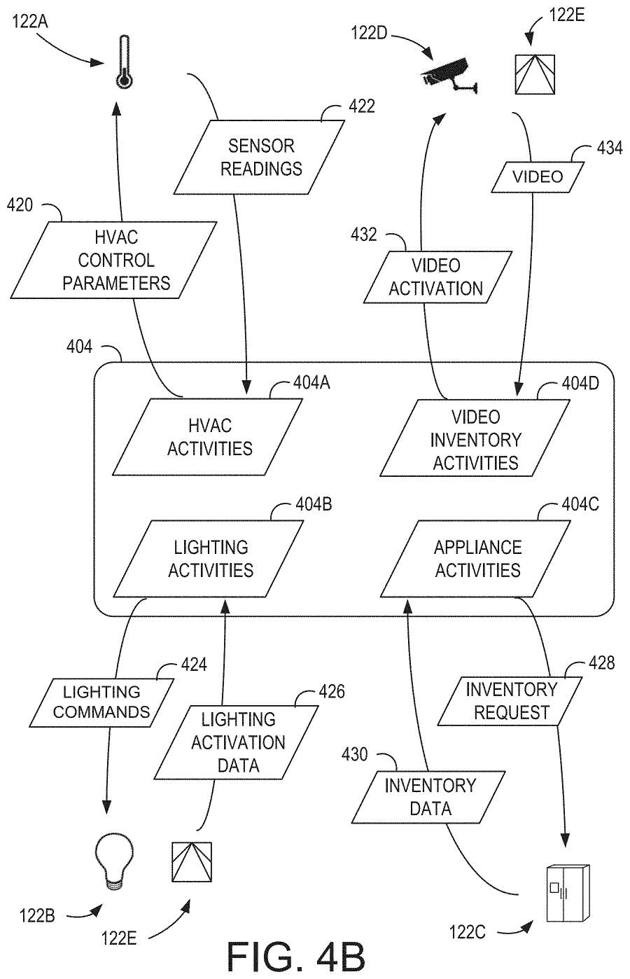

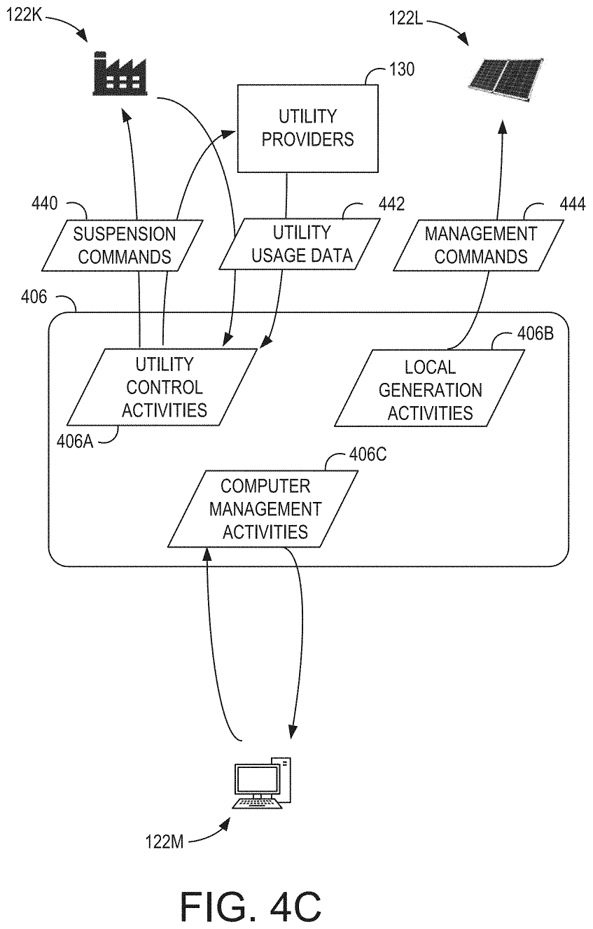

For purposes of illustration, many management activities 342 are discussed in greater detail below with respect to FIG. 4 in the context of succeeding an activation event 340. Each of the management activities 342 described herein are presumed to be selected or otherwise identified as applicable to the management of the estate 120. Some management activities 342 utilize certain types of estate devices 122 and, as such, may have device availability and configuration prerequisites. For example, the ability to control HVAC within a building may utilize access to the thermostat device 122A. As such, for ease of discussion, it is presumed that any management activity 342 described herein that relies upon a particular estate device 122 to facilitate the described operational data or controls has that level of communication and permission with the appropriate devices 122 (e.g., that those devices 122 have been configured in the setup phase).

The setup phase, in some embodiments, includes testing various access and operational controls with each of the devices 122 identified by the particular management activities 342 identified for the estate 120. For example, one management activity 342 may involve limiting access to a primary residence of the focal subject 102. As such, the setup process may include testing connectivity and access between the estate management engine 110 and the access control devices 122G, or initiating the management activity 342 as a test to confirm operational success.

FIGS. 4A-4C illustrates the activation process associated with activating management of the estate 120 by the estate management engine 110 after the activation event(s) 340 has occurred. In an example embodiment, the activation event 340 is the death of the focal subject 102, and where the estate manager 104 is a third party executor for the focal subject 102 responsible for managing the estate 120 until the will of the focal subject 102 is settled. For purposes of illustration, it is presumed that the focal subject 102 had no one else living in their primary residence, and that the estate management protocols 112 for the estate 120 were already configured and staged awaiting the activation event 340. Further, the activation event 340 is triggered within the estate management system 100 based on input from the estate manager 104 indicating that the focal subject 102 has died. In other embodiments, the estate management engine 110 may automatically detect the occurrence of the activation event 340, as described below.

In an example embodiment, occurrence of the activation event 340 causes the estate management engine 110 to initiate the pre-defined management activities 342 for the estate 120. For purposes of illustration, the management activities 342 are categorized as related to securing property, managing property, and managing utilities.

FIG. 4A illustrates various security management activities 402 associated with securing property of the estate 120 using the security devices 310. In some embodiments, the security management activities 402 may be similar to the management activities 342. In an example embodiment, the estate management engine 110 performs security management activities 402 for access control via access management activities 402A, intrusion detection via intrusion detection activities 402B, and video surveillance via video surveillance activities 402C (collectively, security management activities 404).

In an example embodiment, some of the security management activities 402 include access management activities 402A. In some situations, the access management activities 402A may include restricting access to the various premises of the estate 120 (e.g., residences, storage areas, particular rooms of buildings, garage doors, gates, and so forth). As such, in the example embodiment, the access management activities 402A may include an activity associated with changing the access permissions for the various premises or areas within those premises by automatically altering the permission controls within the access control system 122G. For example, in some embodiments, the estate management engine 110 may transmit an access configuration update 410 to the access control system 122G, thereby changing access permissions for access to the properties. The access configuration update 410 may, for example, remove permissions that previously may have existed (e.g., restricting other relatives of the focal subject 102 from the premises), or may permission the estate manager 104 to access the premises (e.g., to allow access for manual tasks).

In some embodiments, the estate management engine 110 may request or otherwise receive access logs and alerts 412 from the access control system 122G. For example, the access management activities 402A may include enabling alerts to be sent with the various premises of the estate 120 are accessed. As such, the estate manager 104 may be able to audit access records, identifying who entered the various premises and when.

In an example embodiment, some of the security management activities 402 include intrusion detection activities 402B. In some situations, the intrusion detection activities 402B may include enabling intrusion detection on the estate 120, enabling motion sensors 122E to detect unauthorized persons on the premises, or routing intrusion alerts to the estate management engine 110 (e.g., from the third party security provider 132). As such, in some embodiments, the estate management engine 110 may communicate activation commands or routing commands to the motion sensors 122E (e.g., activating a particular motion detection protocol) or the intrusion sensors 122F (e.g., routing break-in alerts to the estate management engine 110). In some embodiments, the estate management engine 110 may communicate with the third-party security provider 132 to activate alerting to the estate management engine 110.

In an example embodiment, some of the security management activities 402 include video surveillance activities 402C. In some situations, the video surveillance activities 402C may include capturing video 416 when someone is at the premises (e.g., in conjunction with detected motion from the motion sensors 122E, or via motion detection through video analysis). One common problem with estate management is prospective heirs coming to the estate 120 and removing property before the will can be executed. As such, the estate manager 104 may not only detect that someone accessed the premises of the estate 120, but may also capture video 416 for use in analyzing what those people did while at the estate 120. In some embodiments, the motion sensors 122E may trigger automatic video activation 414 of the camera devices 122D. In some embodiments, storage spaces 122J may also be subject to the various security management activities 402 described herein.

FIG. 4B illustrates various property management activities 404 associated with managing the property of the estate 120 using the property management devices 330. In some embodiments, the property management activities 404 may be similar to the management activities 342. In an example embodiment, the estate management engine 110 performs property management activities 404 for managing the property of the estate 120 via HVAC activities 404A, lighting activities 404B, appliance activities 404C, and video inventory activities 404D (collectively, property management activities 404).

In an example embodiment, some of the property management activities 404 include HVAC activities 404A. Management of internal temperatures can be important in protecting the integrity and value of the estate 120 and its property. For example, excessively high internal temperatures can cause deterioration of belongings within the premises, or excessively low internal temperatures can cause pipes to freeze and rupture in certain geographies. In some situations, the property management activities 404 may include altering heating, air conditioning, or ventilation parameters (e.g., raising or lowering temperature, programming temperature profiles), receiving HVAC alerts (e.g., if air conditioner, furnace, or fans fail), or receiving HVAC data from the thermostat 122A (e.g., tracking internal or external temperatures, usage data). As such, in some embodiments, the estate management engine 110 may communicate HVAC control parameters 420 to the thermostat device 122A. In some embodiments, the estate management engine 110 may collect or otherwise receive sensor readings 422 from the thermostat device 122A. The estate management engine 110 may generate alerts to the estate manager 104 for threshold or error conditions.

In an example embodiment, some of the property management activities 404 include lighting activities 404B. Operating a lighting system throughout the day can enhance security for unoccupied properties, causing the external perception that someone is still living on the premises. In some situations, the property management activities 404 may include altering which lights within the premises are on and off at various times during the day. As such, in some embodiments, the estate management engine 110 may communicate lighting commands 424 to the lighting system 122B. In some embodiments, the lighting system 122B may include motion- or sound-activated lighting (represented in FIG. 4B by the motion sensor 122E). As such, in some embodiments, the estate management engine 110 may collect or otherwise receive lighting activation data 426 from the lighting system 122B or sensors 122E. Such data, similar to the motion sensor data described above, may be used to detect unauthorized access, or the presence of animals 126 within the premises.

In an example embodiment, some of the property management activities 404 include appliance activities. Some appliances such as smart refrigerators or freezers may provide inventory data such as an inventory list of contents or expiration dates of items. In some situations, the property management activities 404 may include collecting inventory data from the appliances. As such, in some embodiments, the estate management engine 110 may communicate inventory requests 428 to the appliances 122C and receive inventory data 430 from the appliances 122C. Such data may be used by the estate manager 104 to prevent spoilage and associated odors. In some embodiments, an IoT water heater may be remotely controlled, and may be used to reduce or eliminate utility usage by the device (e.g., reducing the amount of hot water generated and maintained, or disabling the device such that no hot water is generated or maintained). In some embodiments, certain utility-using appliances such as stoves, ovens, or furnaces may be disabled such as to eliminate gas usage. In some embodiments, the property management activities 404 may include automatically initiating payments to utility providers or other service providers associated with the estate. In some embodiments, the property management activities 404 may include automatically dispensing pet food or water for the animals 126.

In some situations, the property management activities 404 may include video inventory activities 404D. Video inventory activities 404D may include capturing and analyzing video or images from the camera devices 122D to perform a partial inventory of the estate 120. For example, the estate management engine 110 may transmit video activation 432 commands to the various camera devices 122D and receive digital video 434 from the camera devices 122D. That video 434 content may be analyzed automatically (e.g., using object recognition software) to detect items of property on the premises. For example, through video analysis, the estate management engine 110 may be able to automatically detect the presence of pieces of furniture, appliances, electronics, art, books, and so forth. Alternatively, or in addition, the estate manager 104 may manually review the video 434 to generate the partial inventory. In some embodiments, the video 434 or sensor readings from the motion sensors 122E may be used to detect the presence of animals 126 on the premises (e.g., via object recognition, motion detection, manual video review).

In some embodiments, the property management activities 404 may include vehicle control activities (not separately shown). Some vehicles 122H, such as personal automobiles, may be configured to allow certain security features to protect the vehicles 122H from theft or other unauthorized use. Some vehicles 122H may provide location services such that the vehicles 122H may be located. As such, the vehicle control activities may include transmitting commands to remotely deactivate the vehicles 122H, lock the vehicles 122H, command the vehicles 122H to return home or to a pre-determined location, or collect usage and location information from the vehicles 122H.

FIG. 4C illustrates various utility management activities 406 associated with managing the utilities used by the estate 120 via the utility devices 320. In some embodiments, the utility management activities 406 may be similar to the management activities 342. In an example embodiment, the estate management engine 110 performs utility management activities 406 for managing the utilities used by the estate 120 via utility control activities 406A, local generation activities 406B, and computer management activities 406C (collectively, utility management activities 406).

In an example embodiment, some of the utility management activities 406 include utility control activities 406A. Management of utility usage, such as electricity, water, gas, waste and recycling collection, sewer, cable television, and Internet access can help minimize expenses and retain the value of the estate 120. In some situations, the utility control activities 406A may include automatically suspending certain services, such as waste and recycling collection or water usage. As such, in some embodiments, the estate management engine 110 may communicate suspension commands 440 to the utility providers 130 or to local utility management devices 122K on the premises of the estate 120. In some embodiments, the utility control activities 406A may include requesting or otherwise receiving utility usage data 442 for the utility 122K (e.g., from the utility provider 130).

In an example embodiment, some of the utility management activities 406 include local generation activities 406B associated with the distributed generation systems 122L. Management of local electric generation, such as solar or wind, can help mitigate other electric expense and retain the value of the estate 120. In some situations, the local generation activities 406B may include collecting performance data associated with the local distributed generation systems 122L, alerting in response to performance-related problems, or activating or deactivating the local distributed generation systems 122L. In some embodiments, the estate management engine 110 may communicate management commands 444 to the local distributed generation systems 122L.

In an example embodiment, some of the utility management activities 406 include computer management activities 406C associated with the computer devices 122M on the premises. Some focal subjects 102 may have various computer devices 122M that may be managed by the estate management engine 110 for various purposes. Computer management activities 406C may include, for example, resetting account passwords on computer devices 122M or associated accounts (e.g., to prevent unauthorized use, or to obtain control of the accounts by the estate management engine 110), initiating backups of locally or remotely stored file systems (e.g., to protect retention of data as an asset of the estate 120), disabling some devices from network access (e.g., removing Wi-Fi access for devices not essential to the estate management system 100), or tracking location or usage of the computer devices 122M (e.g., determining location of smartphones, tablets).

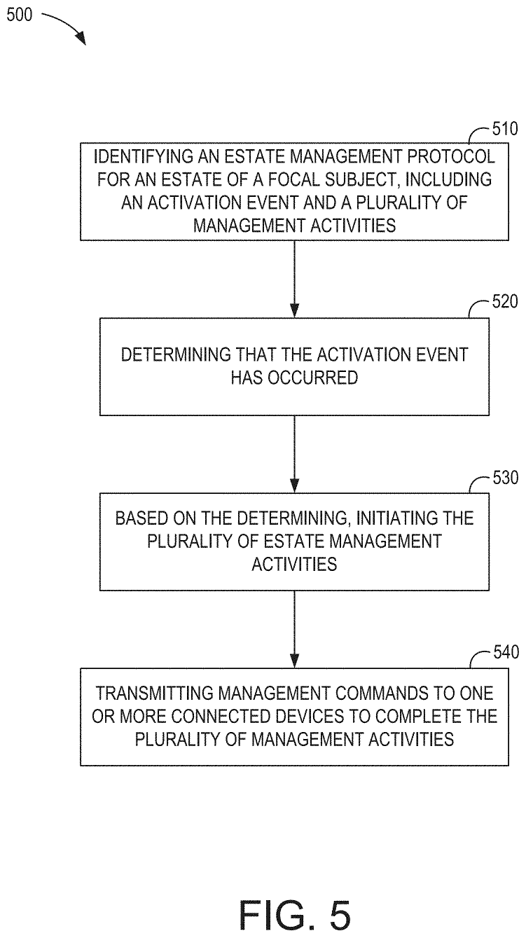

FIG. 5 illustrates an example computer-implemented method 500 for managing the estate 120 of the focal user 102, according to some embodiments. The computer-implemented method 500, hereafter referred to as “the method 500,” is performed by a computing device comprising at least one hardware processor and a memory. In an example embodiment, the method 500 includes identifying an estate management protocol associated with an estate of a focal subject, the estate management protocol includes an activation event and a plurality of management activities, the activation event defining a triggering event after which the system performs the plurality of management activities to manage the estate of the focal subject (see operation 510).

In the example embodiment, the method 500 also includes determining that the activation event has occurred (see operation 520). The method 500 further includes, based on the determining, initiating the plurality of estate management activities to manage aspects of the estate of the focal subject using one or more connected devices of the estate (see operation 530). The method 500 also includes transmitting management commands to the one or more connected devices to complete the plurality of management activities (see operation 540).

In some embodiments, the plurality of estate management activities includes an access management activity configured to alter access control within an access control system at a first premise of the estate, and transmitting management commands to the one or more connected devices includes transmitting an access configuration update to the access control system. In some embodiments, the plurality of estate management activities includes a video surveillance activity configured to capture digital video from one or more camera devices at a first premise of the estate, and transmitting management commands to the one or more connected devices includes transmitting a video activation command to the one or more camera devices.

In some embodiments, the method 500 also includes receiving digital video from the one or more camera devices, performing object recognition on the digital video to generate a plurality of recognized objects, and constructing an estate inventory including the plurality of recognized objects.

In some embodiments, transmitting a video activation command to the one or more camera devices includes transmitting the video activation command based on detecting, by a motion sensor on the premise, motion on the premise. In some embodiments, the plurality of estate management activities includes a vehicle security activity configured to disable a vehicle of the estate, and transmitting management commands to the one or more connected devices includes transmitting a disable command to the vehicle. In some embodiments, the plurality of estate management activities includes a heating, ventilation, and air conditioning (HVAC) activity configured to manage the HVAC within a first premise of the estate, and transmitting management commands to the one or more connected devices includes transmitting HVAC control parameters to a thermostat device.

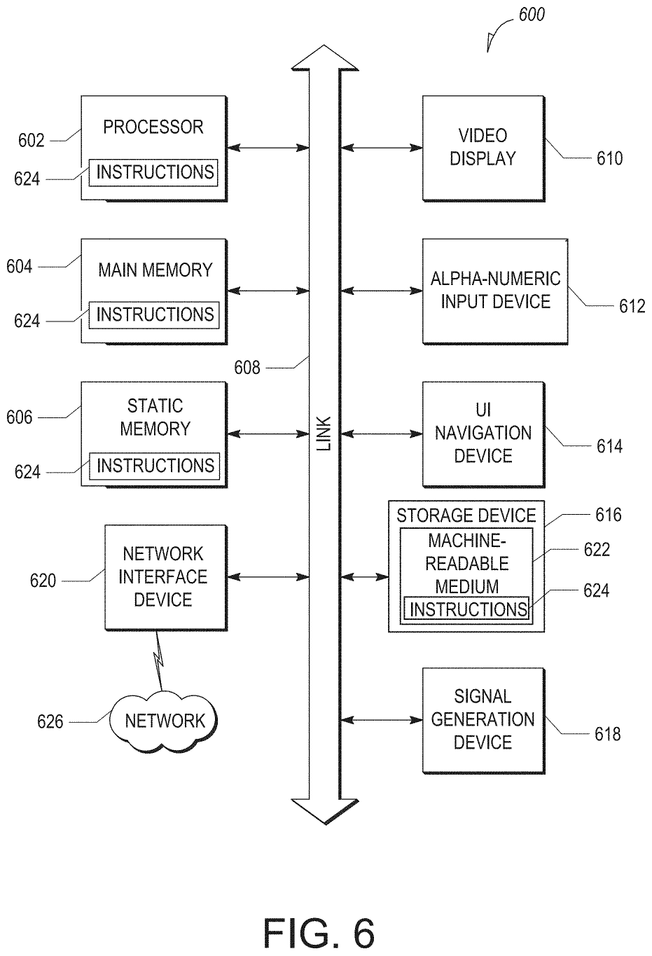

FIG. 6 is a block diagram illustrating a machine in the example form of a computer system 600, within which a set or sequence of instructions can be executed to cause the machine to perform any one of the methodologies discussed herein, according to some embodiments. In alternative embodiments, the machine operates as a standalone device or can be connected (e.g., networked) to other machines. In a networked deployment, the machine can operate in the capacity of either a server or a client machine in server-client network environments, or it can act as a peer machine in peer-to-peer (or distributed) network environments. The machine can be a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 can further include a video display unit 610, an alphanumeric input device 612 (e.g., a keyboard), and a user interface (UI) navigation device 614 (e.g., a mouse). In one embodiment, the video display unit 610, alphanumeric input device 612, and UI navigation device 614 are incorporated into a touch-screen display. The computer system 600 can additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 can also reside, completely or at least partially, within the main memory 604, within the static memory 606, and/or within the processor 602 during execution thereof by the computer system 600, with the main memory 604, static memory 606, and the processor 602 also constituting machine-readable media 622.

While the machine-readable medium 622 is illustrated in an example embodiment to be a single medium, the term “machine-readable medium” can include a single medium or multiple media (e.g., a centralized or distributed database, and/or associated caches and servers) that store the one or more instructions 624. The term “machine-readable medium” shall also be taken to include any tangible medium that is capable of storing, encoding, or carrying instructions (e.g., instructions 624) for execution by the machine and that cause the machine to perform any one or more of the methodologies of the present disclosure or that is capable of storing, encoding, or carrying data structures utilized by or associated with such instructions 624. The term “machine-readable medium” shall accordingly be taken to include, but not be limited to, solid-state memories, and optical and magnetic media. Specific examples of machine-readable media 622 include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 can further be transmitted or received over a communications network 626 using a transmission medium via the network interface device 620 utilizing any one of a number of well-known transfer protocols (e.g., Hypertext Transfer Protocol (HTTP)). Examples of communication networks include a local area network (LAN), a wide area network (WAN), the Internet, mobile telephone networks, plain old telephone service (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

1. An estate management system comprising:
an activation module, which, when executed on at least one hardware processor, is configured to:
identify an estate management protocol associated with an estate of a focal subject, the estate management protocol including activation events and a plurality of management activities, the activation events defining triggering events associated with unavailability of the focal subject after which the system performs the plurality of management activities to manage the estate of the focal subject, wherein the plurality of management activities includes an access management activity configured to alter access control within an access control system at a physical premises of the estate;
monitor the physical premises of the estate using a set of physical sensors, wherein the set of physical sensors includes a camera device, motion sensors, and an intrusion sensor;
receive digital video from the camera device;
perform a first object recognition on the digital video to generate a plurality of recognized objects without human intervention; and
construct an estate inventory including the plurality of recognized objects;
identify in response to activation of at least one physical sensor of the set of physical sensors, an occurrence of the activation events, wherein identifying the occurrence of the activation events includes analyzing data captured by each of the camera device, the motion sensors, and the intrusion sensor;
process the occurrence of the activation events;
activate the estate management protocol based on processing the occurrence of the activation events and the estate management protocol; and
generate an indication that the activation events have occurred;
an estate security module, which, when executed on at least one hardware processor, is configured to:
receive the indication from the activation module that the activation events have occurred; and
based on receiving the indication that the activation events have occurred, initiate the plurality of management activities to manage aspects of the estate of the focal subject using one or more connected devices of the estate, wherein hg plurality of management activities includes:
receiving additional digital video from the camera device;
performing a second object recognition on the additional digital video to generate a partial inventory of the plurality of recognized objects;
comparing the partial inventory with the estate inventory to detect property removal; and
transmitting an access configuration update to the access control system via a communication module of an estate management engine, the access configuration update instructing the access control system to remove a previously granted permission to the physical premises when the activation events occur, wherein the activation events include a lack of presence of the focal subject at the physical premises, thereby limiting access to the physical premises in response to determining the occurrence of the activation events by users associated with the focal subject.

2-4. (canceled)

5. The system of claim 1, wherein the camera device captures the digital video based on detecting, by one of the motion sensors, motion on a first physical premises of the estate.

6. The system of claim 1, wherein the plurality of estate management activities includes a vehicle security activity configured to disable a vehicle of the estate, and wherein initiating includes transmitting a disable command to the vehicle.

7. The system of claim 1, wherein the plurality of estate management activities includes a heating, ventilation, and air conditioning (HVAC) activity configured to manage an HVAC within a first physical premises of the estate, and wherein initiating includes transmitting HVAC control parameters to a thermostat device.

8. A computer-implemented method for operating an estate management system having an activation module, an estate security module, and a communication module, the method comprising:
identifying, at the activation module, an estate management protocol associated with an estate of a focal subject, the estate management protocol including activation events and a plurality of management activities, the activation events defining triggering events associated with unavailability of the focal subject after which the plurality of management activities are performed to manage the estate of the focal subject, wherein the plurality of management activities includes an access management activity configured to alter access control within an access control system at a physical premises of the estate;
monitoring the physical premises of the estate using a set of physical sensors, wherein the set of physical sensors includes a camera device, motion sensors, and an intrusion sensor;
receive digital video from the camera device;
perform a first object recognition on the digital video to generate a plurality of recognized objects without human intervention; and
construct an estate inventory including the plurality of recognized objects;
identifying, at the activation module and in response to activation of at least one physical sensor of the set of physical sensors, an occurrence of the activation events, wherein identifying the occurrence of the activation events includes analyzing data captured by each of the camera device, the motion sensors, and the intrusion sensor;
processing, at the activation module, the occurrence of the activation events;
activating, at the activation module, the estate management protocol based on processing the occurrence of the activation events and the estate management protocol;
generating, at the activation module, an indication that the activation events have occurred;
receiving, at the estate security module, the indication from the activation module that the activation events have has occurred; and
based on receiving the indication that the activation events have occurred, initiating, at the estate security module, the plurality of management activities to manage aspects of the estate of the focal subject using one or more connected devices of the estate, wherein the plurality of management activities includes:
receiving additional digital video from the camera device;
performing a second object recognition on the additional digital video to generate a partial inventory of the plurality of recognized objects; and
comparing the partial inventory with the estate inventory to detect property removal; and
transmitting an access configuration update to the access control system via the communication module, the access configuration update instructing the access control system to remove a previously granted permission to the physical premises when the activation events occur, wherein the activation events include a lack of presence of the focal subject at the physical premises, thereby limiting access to the physical premises in response to determining the occurrence of the activation events by users associated with the focal subject.

9-11. (canceled)

12. The method of claim 8, wherein the camera device captures the digital video based on detecting, by one of the motion sensors on the physical premises, motion on a first physical premises of the estate.

13. The method of claim 8, wherein the plurality of estate management activities includes a vehicle security activity configured to disable a vehicle of the estate, and wherein initiating includes transmitting a disable command to the vehicle.

14. The method of claim 8, wherein the plurality of estate management activities includes a heating, ventilation, and air conditioning (HVAC) activity configured to manage an HVAC within a first physical premises of the estate, and wherein initiating includes transmitting HVAC control parameters to a thermostat device.

15. A non-transitory computer-readable storage medium, the computer-readable storage medium including instructions that, when executed by an estate management system having an activation module, an estate security module, and a communication module, cause the estate management system to perform operations comprising:
identifying, at the activation module, an estate management protocol associated with an estate of a focal subject, the estate management protocol includes activation events and a plurality of management activities, the activation events defining triggering events associated with unavailability of the focal subject after which the plurality of management activities are performed to manage the estate of the focal subject, wherein the plurality of management activities includes an access management activity configured to alter access control within an access control system at a physical premises of the estate;
monitoring the physical premises of the estate using a set of physical sensors, wherein the set of physical sensors includes a camera device, motion sensors, and an intrusion sensor;
receive digital video from the camera device;
perform a first object recognition on the digital video to generate a plurality of recognized objects without human intervention; and
construct an estate inventory including the plurality of recognized objects;
identifying, at the activation module and in response to activation of at least one physical sensor of the set of physical sensors, an occurrence of the activation events, wherein identifying the occurrence of the activation events includes analyzing data captured by each of the camera device, the motion sensors, and the intrusion sensor;
processing, at the activation module, the occurrence of the activation events;
activating, at the activation module, the estate management protocol based on processing the occurrence of the activation events and the estate management protocol; and
generating, at the activation module, an indication that the activation events have occurred;
receiving, at the estate security module, the indication from the activation module that the activation event has occurred;
based on receiving the indication that the activation events have occurred, initiating, at the estate security module, the plurality of management activities to manage aspects of the estate of the focal subject using one or more connected devices of the estate, wherein the plurality of management activities includes:
receiving additional digital video from the camera device;
performing a second object recognition on the additional digital video to generate a partial inventory of the plurality of recognized objects; and
comparing the partial inventory with the estate inventory to detect property removal; and
transmitting an access configuration update to the access control system via the communication module, the access configuration update instructing the access control system to remove a previously granted permission to the physical premises when the activation events occur, wherein the activation events include a lack of presence of the focal subject at the physical premises, thereby limiting access to the physical premises in response to determining the occurrence of the activation events by users associated with the focal subject.

16-18. (canceled)

19. The non-transitory computer-readable storage medium of claim 15, wherein the plurality of management activities includes a vehicle security activity configured to disable a vehicle of the estate, and wherein initiating includes transmitting a disable command to the vehicle.

20. The non-transitory computer-readable storage medium of claim 15, wherein the plurality of management activities includes a heating, ventilation, and air conditioning (HVAC) activity configured to manage the HVAC within a first physical premises of the estate, and wherein initiating includes transmitting HVAC control parameters to a thermostat device.

21-23. (canceled)
